(19) United States
(12) Patent Application Publication
(10) Pub. No.: US 2023/0161623 A1
(43) Pub. Date: May 25, 2023

(54) VEHICLE AS A DISTRIBUTED COMPUTING RESOURCE

(71) Applicant: Volvo Car Corporation, Göteborg (SE)

(72) Inventor: Raik Orbay, Goteborg (SE)

(21) Appl. No.: 17/530,928

(22) Filed: Nov. 19, 2021

(51) Int. Cl. G06F 9/50; H04L 12/26; H04W 4/44; G05D 1/02

(52) U.S. Cl. CPC G06F 9/5027; H04L 43/0888; H04W 4/44; G05D 1/0212; G06F 2209/505

(57) ABSTRACT

Distributed computing vehicles (e.g., using a computerized tool) are enabled. For example, a system can comprise a memory that stores computer executable components, and a processor that executes the computer executable components stored in the memory, wherein the computer executable components comprise: a request component that determines a compute request received via a network from a network device registered to use the system, and a resource component that, in response to a compute criterion associated with a vehicle communicatively coupled to the network being determined to be satisfied, allocates at least some compute resources of the vehicle to the compute request.

### TECHNICAL FIELD

The disclosed subject matter relates to vehicles (e.g., transportation vehicles) and, more particularly, to leveraging of vehicles and associated components, such as autonomous driving components, in a distributed computing fabric.

### BACKGROUND

As the world becomes increasingly digital, demand for data processing capabilities also increases. Similarly, the demand to transmit associated data also increases. Such demands can increase costs for associated hardware and services, as more resources often need to be added to a network in order to keep pace with demand. Compounding this problem, supply chains, at times, have experienced shortages, which have resulted in a periodic lack of availability of integrated circuits and other electronic components. Existing computing solutions do not efficiently distribute available computing resources, resulting in increased demand for even more integrated circuits (e.g., semiconductor chips), thus further constraining supplies, increasing costs, and wasting valuable resources. Additionally, increased abstraction of services can lead to increased demand in computational capacities. Further, existing cloud-based solutions can lead to increased carbon emissions when ramping-up cloud-based computing capacities.

The above-described background relating to distributed computing (e.g., of vehicles) is merely intended to provide a contextual overview of some current issues and is not intended to be exhaustive. Other contextual information may become further apparent upon review of the following detailed description.

### SUMMARY

The following presents a summary to provide a basic understanding of one or more embodiments of the invention. This summary is not intended to identify key or critical elements or delineate any scope of the particular embodiments or any scope of the claims. Its sole purpose is to present concepts in a simplified form as a prelude to the more detailed description that is presented later. In one or more embodiments described herein, systems, devices, computer-implemented methods, and/or computer program products that facilitate vehicles as distributed computing resources.

As alluded to above, distributed computing (e.g., using an automobile) can be improved in various ways, and various embodiments are described herein to this end and/or other ends.

According to an embodiment, a system can comprise a memory that stores computer executable components, and a processor that executes the computer executable components stored in the memory, wherein the computer executable components can comprise: a request component that determines a compute request received via a network from a network device registered to use the system, and a resource component that, in response to a compute criterion associated with a vehicle communicatively coupled to the network being determined to be satisfied, allocates at least some compute resources of the vehicle to the compute request.

According to another embodiment, a non-transitory machine-readable medium can comprise executable instructions that, when executed by a processor, facilitate performance of operations, comprising: determining a compute request received via a network from a network device registered with a vehicle communicatively coupled to the network, and in response to a compute criterion associated with the vehicle being determined to be satisfied, allocating at least some compute resources of the vehicle to the compute request.

According to yet another embodiment, a method can comprise: determining, by a device comprising a processor, a compute request received via a network from a network device registered with a vehicle communicatively coupled to the network, and in response to a compute criterion associated with the vehicle being determined to be satisfied, allocating, by the device, at least some compute resources of the vehicle to the compute request.

### BRIEF DESCRIPTION OF DRAWINGS

FIG. 1 illustrates a block diagram of an exemplary system in accordance with one or more embodiments described herein.

FIG. 2 illustrates a block diagram of an exemplary system in accordance with one or more embodiments described herein.

FIG. 3 illustrates a block diagram of an exemplary system in accordance with one or more embodiments described herein.

FIG. 4 illustrates a depiction of an example, non-limiting driving scenario in accordance with one or more embodiments described herein.

FIG. 5 illustrates a depiction of an example, non-limiting scenario in accordance with one or more embodiments described herein.

FIG. 6 is an exemplary flowchart of a process associated with distributed computing (e.g., using a vehicle) in accordance with one or more embodiments described herein.

FIG. 7 illustrates a block flow diagram for a process associated with distributed computing (e.g., using a vehicle) in accordance with one or more embodiments described herein.

FIG. 8 illustrates a block flow diagram for a process associated with distributed computing (e.g., using a vehicle) in accordance with one or more embodiments described herein.

FIG. 9 is an example, non-limiting computing environment in which one or more embodiments described herein can be implemented.

FIG. 10 is an example, non-limiting networking environment in which one or more embodiments described herein can be implemented.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

It will be understood that when an element is referred to as being “coupled” to another element, it can describe one or more different types of coupling including, but not limited to, chemical coupling, communicative coupling, capacitive coupling, electrical coupling, electromagnetic coupling, inductive coupling, operative coupling, conductive coupling, acoustic coupling, ultrasound coupling, optical coupling, physical coupling, thermal coupling, and/or another type of coupling. As referenced herein, an “entity” can comprise a human, a client, a user, a computing device, a software application, an agent, a machine learning model, an artificial intelligence, and/or another entity. It should be appreciated that such an entity can facilitate implementation of the subject disclosure in accordance with one or more embodiments the described herein.

Autonomous driving systems require significant computing resources. Therefore, vehicles comprising such autonomous driving systems possess significant computing capabilities, which can sometimes be left idle (e.g., when autonomous driving is not in use or enabled). In this regard, such vehicles can be utilized in a distributed processing fabric in order to allocate unutilized or underutilized computing resources (e.g., of an autonomous driving system or other vehicle systems), thus reducing waste of available computing resources. For example, when a vehicle is engaged in autonomous driving, the vehicle will utilize its own resources (e.g., automated driving compute resources), and may not be able to allocate any extra resources. However, when such a vehicle is parked and/or charging, such resources can be in an idle state, and can therefore be leveraged as processing or worker nodes in a distributed processing network.

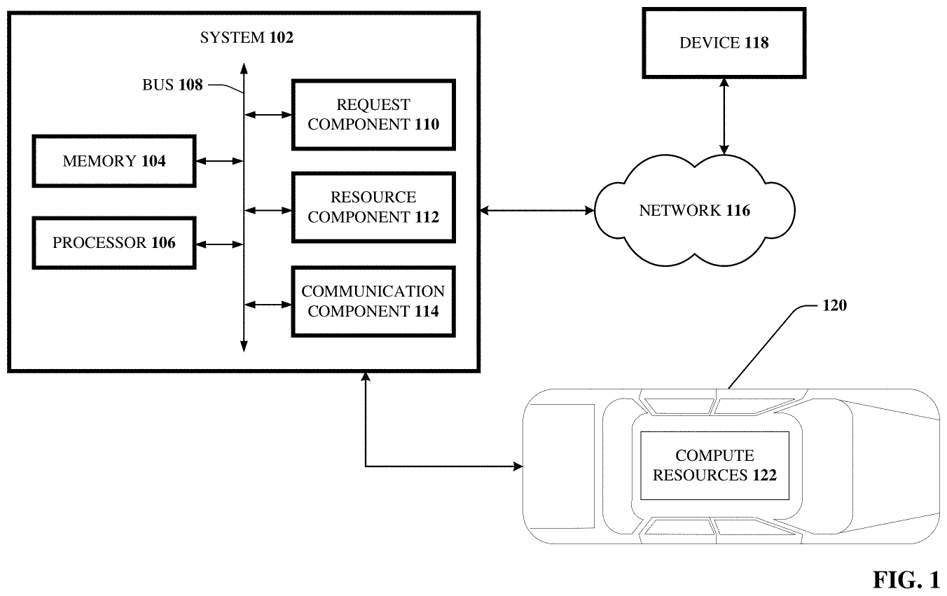

Turning now to FIG. 1, there is illustrated an example, non-limiting system 102 in accordance with one or more embodiments herein. System 102 can comprise a computerized tool, which can be configured to perform various operations relating to distributed computing (e.g., using a vehicle). The system 102 can comprise one or more of a variety of components, such as memory 104, processor 106, bus 108, request component 110, resource component 112, and/or communication component 114.

In various embodiments, one or more of the memory 104, processor 106, bus 108, request component 110, resource component 112, communication component 114, device 118, and/or vehicle 120 can be communicatively or operably coupled (e.g., over a bus or wireless network) to one another to perform one or more functions of the system 102.

According to an embodiment, the request component 110 can determine a compute request received via a network (e.g., network 116, using a communication component 114) from a network device (e.g., device 118) registered to use the system (e.g., system 102). In one or more embodiments, a vehicle (e.g., vehicle 120) (e.g., a car, truck, farm equipment, watercraft, aircraft, train, or another suitable vehicle) can comprise the system 102. In further embodiments, the system 102 can comprise a vehicle (e.g., vehicle 120). It is noted that the device 118 can comprise one or more of a variety of devices communicatively coupled to the system 102 (e.g., over the network 116). For example, the device 118 can comprise another vehicle (e.g., comprising a similar system 102). In another example, the device 118 can comprise a server or another computing device or component (e.g., in a fixed location or portable). For example, such a device 118 can be located in a building, warehouse, home, or in another location. It is noted that determining a compute request (e.g., by the request component 110) can comprise determining a type of compute request that is requested and associated information (e.g., resources requested, length of time requested, associated location(s), associated inventive(s), or other suitable information).

In various embodiments herein, the vehicle 120 can comprise a plurality of resource components (e.g., compute resources 122, such as autonomous driving components, processors or processing units, memory, network components, sensors such as radar sensors, lidar units, or cameras, or other suitable resource components). According to an embodiment, the resource component 112 can, in response to a compute criterion associated with a vehicle (e.g., vehicle 120) communicatively coupled to the network (e.g., network 116) being determined to be satisfied (e.g., by the resource component 112), allocate at least some compute resources (e.g., compute resources 122) of the vehicle to the compute request. It is noted that the “at least some compute resources” that are allocated by the resource component 112 can be commensurate with the compute request or with available compute resources (e.g., compute resources not in use by the vehicle 120. In various embodiments, allocating at least some compute resources 122 of the vehicle 120 to the compute request can comprise allocating (e.g., by the resource component 112) at least one processing unit of the plurality of processing units. In further embodiments, allocating at least some compute resources 122 of the vehicle 120 to the compute request can comprise allocating (e.g., by the resource component 112) at least one processing thread of a plurality of processing threads. It is noted that allocating such compute resources of the vehicle 120 can be based on respective carbon emissions (e.g., of the vehicle 120 or other vehicles or entities). In various embodiments, the compute criterion herein can comprise a defined threshold utilization percentage of the compute resources 122 by the vehicle. For example, a defined threshold utilization percentage herein can comprise 50% of available computing resources of the vehicle. It is noted that such computing resources can comprise autonomous driving compute resources (e.g., or other associated autonomous driving resources) of the vehicle. Additionally/alternatively, resources can comprise media hardware, GPUs, or other suitable components of the vehicle. In this example, if a vehicle is using less than (e.g., or equal to) 50% of its available computing resources, the compute criterion herein can be determined (e.g., by the resource component 112) to be satisfied. It is noted, for example, that a ride-share entity can utilize resources to tailor respective route planning, resource distribution, unplanned maintenance handling, or other suitable operations.

In various embodiments, the resource component 112 can function as an orchestrator component (e.g., capable of task switching), which can be utilized to manage tasks associated with the compute resources 122. In this regard, the resource component 112 can allocate one or more individual compute resources of the compute resources 122 (e.g., based on vehicle 120 needs, compute requests, or other suitable factors).

In some embodiments, the at least some compute resources 122 of the vehicle 120 can comprise a containerized worker node in a compute cluster (e.g., Kubernetes cluster). In this regard, the compute resources 122 of the vehicle can comprise virtual and/or physical compute resources (e.g., as managed by a control plane over the network 116, in which the compute resources of the vehicle can be scheduled to execute a containerized task or application (e.g., in response to a compute criterion associated with the vehicle communicatively coupled to the network being determined to be satisfied). In further embodiments, said control plane can comprise the resource component 112. In various embodiments, a non-containerized worker node (e.g., using a multiprocessing library) can be utilized (e.g., secured using blockchain technology or another secure security mechanism or component).

In various embodiments, compute resources 122 herein can comprise compute resources that are not presently in use by the vehicle 120 (e.g., in an idle state), such as media processing resources, navigation resources, autonomous driving resources, or other suitable resources. In further embodiments, the compute resources 122 herein can comprise compute resources that are not presently in use by a vehicle within a defined range of the vehicle 122. For instance, such compute resources 122 (e.g., autonomous driving resources) can be in an idle state when the vehicle 120 is not engaged in autonomous driving or when the vehicle 120 is parked or charging. In other embodiments, the compute resources herein can comprise compute resources presently in use. In this regard, such compute resources can be reallocated (e.g., by the resource component 112 in response to an authorization, as later discussed in greater detail). It is noted that the compute criterion being determined (e.g., by the resource component 112) to be satisfied can comprise a determination (e.g., by the resource component 112) that the vehicle 120 is charging. In this regard, allocation of the compute resources 122 would not reduce a charge state of an associated vehicle 120 (e.g., an electric vehicle) as compute resources 122 (e.g., autonomous driving compute resources) are often idle when such an electric vehicle is charging (e.g., and not in a driving state).

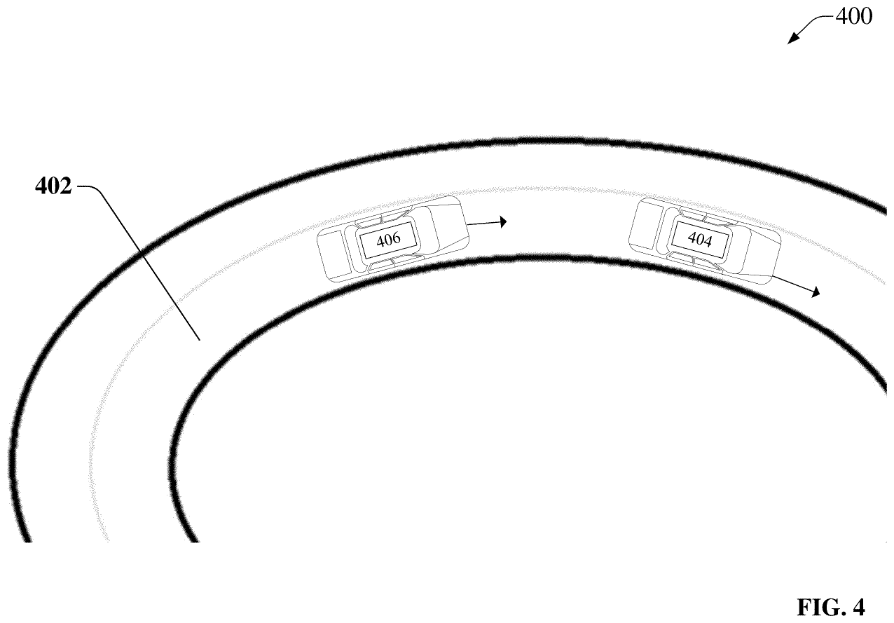

According to an example, the vehicle 120 can comprise a first vehicle, and the network device 118 can comprise a second vehicle (see, e.g., FIG. 4). In this regard, the second vehicle can navigate behind the first vehicle on a same road as the first vehicle, and the compute request can comprise a road condition determination request. Such a road condition determination request can comprise a request for information regarding one or more of a traffic condition (e.g., road congestion, traffic speed, or other traffic information), a road quality (e.g., potholes, bumps, or other road quality information), road hazards (e.g., rain, snow, debris, obstacles, or other road hazard information), emergency vehicles (e.g., presence police cars or ambulances on the road, or other emergency vehicle information), an accident (e.g., a crash, or other accident-related information), or other suitable road condition information. In this regard, the first vehicle can determine such road condition information (e.g., using one or more sensors of the vehicle 120) and provide such road condition information to the second vehicle (e.g., via a communication component 114 and/or over the network 116). According to an example, such sensors can comprise one or more of radar sensors, lidar units, or cameras, or other suitable sensors.

In an implementation, the resource component 112 can, in response to a determination (e.g., by the resource component 112) that the vehicle 120 requires compute resources 122 of the vehicle 120 that are presently in use by the device (e.g., network device) 118, revoke the allocation of the compute resources of the vehicle 120 presently in use by the network device (e.g., the device 118). For example, compute resources or other resources of the vehicle 120 can be previously allocated (e.g., to the device 118 by the resource component 112), and the vehicle 120 cab later (e.g., subsequent to the allocation) require said resources (e.g., to perform one or more tasks such as autonomous driving or other computing tasks associated with the vehicle). In this situation, the resource component 112 can revoke the allocation (e.g., terminate) of the compute resources of the vehicle 120 presently in use by the device 118 and reallocate said resources to the vehicle 120.

According to an embodiment, the communication component 114 can determine network status information representative of a signal strength and connection speed between the vehicle 120 and the network 116. In this regard, allocating at least some compute resources of the vehicle to the compute request can further comprise allocating (e.g., by the resource component 112) at least some compute resources of the vehicle 120 to the compute request in response the network status information being determined (e.g., by the communication component 114) to satisfy a network status threshold. For example, such a network status threshold can be associated with a defined signal strength, network connection type (e.g., 4G, 5G low band, 5G mid band, 5G mmWave, 6G, Bluetooth, UHF, VHF, AM, FM, etc.), network throughput, network latency, or another suitable network status threshold. It is noted that the communication component 114 can comprise the hardware required to implement a variety of communication protocols (e.g., infrared (“IR”), shortwave transmission, near-field communication (“NFC”), Bluetooth, Wi-Fi, long-term evolution (“LTE”), 3G, 4G, 5G, 6G, global system for mobile communications (“GSM”), code-division multiple access (“CDMA”), satellite, visual cues, radio waves, acoustic waves, ultrasound, L-band, etc.) In an embodiment, the resource component 112 can determine and/or estimate carbon emissions associated with utilizing compute resources described herein. For example, the resource component 112 can determine whether it would generate more carbon emissions to conduct compute functions locally (e.g., via a vehicle 120) or remotely. For example, if local resources are already active and/or at normal operating temperature, utilizing local resources can be determined to generate less carbon emission than initializing remote resources (e.g., in a cloud computing environment or of another vehicle). Further, such a determination can be based on emissions standards in one or more locations or jurisdictions.

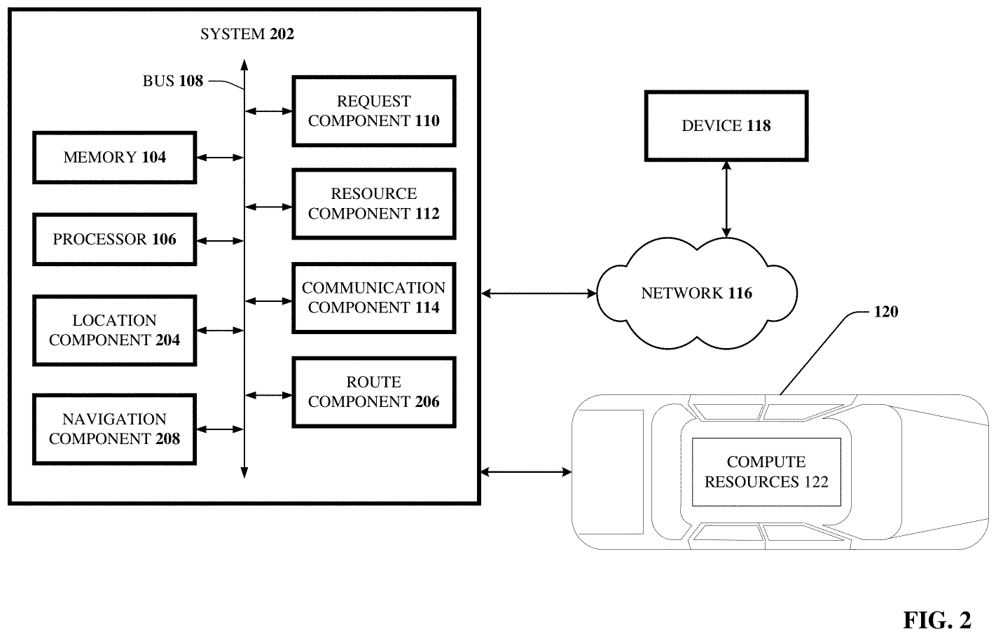

Turning now to FIG. 2, there is illustrated an example, non-limiting system 202 in accordance with one or more embodiments herein. System 202 can comprise a computerized tool, which can be configured to perform various operations relating to distributed computing (e.g., using a vehicle). The system 202 can be similar to system 102, and can comprise one or more of a variety of components, such as memory 104, processor 106, bus 108, request component 110, resource component 112, and/or communication component 114. The system 202 can additionally comprise a location component 204, route component 206, and/or navigation component 208.

In various embodiments, one or more of the memory 104, processor 106, bus 108, request component 110, resource component 112, communication component 114, device 118, vehicle 120, location component 204, route component 206, and/or navigation component 208 can be communicatively or operably coupled (e.g., over a bus or wireless network) to one another to perform one or more functions of the system 202. It is noted that, in various embodiments, system 202 or other systems herein can be utilized in connections with ride sharing entities and/or vehicle to vehicle platforms and associated systems.

According to an embodiment, the location component 204 can determine a location (e.g., a geographic location) of the vehicle 120. In this regard, the compute criterion being determined to be satisfied can comprise a determination (e.g., by the location component 204) that the vehicle 120 is located within a threshold distance of the network device 118. For example, the compute request can comprise a request to facilitate direct communication between the network device 116 and the vehicle 120 (e.g., via the communication component 114). In this regard, if the vehicle is within the threshold distance, the communication component 114 can facilitate the direct communication. Further in this regard, unprocessed data can be sent from the device 118 to the vehicle 120, processed using the compute resources 122 of the vehicle 120, and returned as processed data to the device 118. In further embodiments, such communication can be conducted (e.g., using the communication component 114) over the network 116 (and/or between vehicles directly). Therefore, two-way communication between the vehicle 120 and other entities (e.g., device 118) is enabled herein.

In further embodiments, the route component 206 can determine route information representative of a route of the vehicle 120. In this regard, the compute criterion being determined to be satisfied can further comprise a determination (e.g., by route component 206), based on the route information, that the vehicle 120 will remain within the threshold distance of the network device 118 for at least a threshold amount of time. Further in this regard, the route component 206 can predict the amount of time that the vehicle 120 will remain within the threshold distance of the network device 118, for instance, based on a trajectory (e.g., speed, direction) of the vehicle 120, a defined route (e.g., entered into a GPS of the vehicle 120), a schedule associated with the vehicle 120 or a user or mobile device associated with the vehicle 120, or other suitable information on which to base such a prediction. For example, the route component 206 can access route information utilized by a GPS of the vehicle 120. The route component 206 can analyze such route information, and determine and/or predict the amount of time that the vehicle 120 will remain within the threshold distance of the network device 118 (e.g., according to the compute request) (e.g., within a geofence). In this regard, if the vehicle is predicted to remain within the threshold distance for a threshold amount of time (e.g., according to the compute request), the communication component 114 can facilitate the direct communication. Further in this regard, unprocessed data can be sent from the device 118 to the vehicle 120, processed using the compute resources 122 of the vehicle 120, and return as processed data to the device 118. In further embodiments, such communication can be conducted (e.g., using the communication component 114) over the network 116.

According to an embodiment, the navigation component 208 can determine status information representative of a navigational status of the vehicle 120, and in response to a status criterion being determined to be satisfied by the status information, autonomously navigate the vehicle to a location associated with the compute request. It is noted that the compute request can comprise location data representative of the location. Additionally, such a status criterion can comprise a vehicle being in an idle state (e.g., charging, parked, etc.) for a defined or predicted amount of time. In this regard, the navigation component 208 can autonomously navigate the vehicle to the location (e.g., in response to a determination by the navigation component 208 or another suitable component herein that vehicle 120 will be, or is predicted to be, in an idle state for a defined amount of time). Further, such navigation can be based on emissions output and/or based on a respective emission quota. In further embodiments, the compute request can comprise a network traffic request. In this regard, the location can comprise a defined region for cellular coverage to be supplemented via network hardware of the vehicle. For example, the vehicle 120 can be autonomously navigated (e.g., using the navigation component 208) to said location in order to supplement cellular coverage (e.g., by utilizing communication component(s) of the vehicle 120 and/or system 202). In this regard, the vehicle 120 can operate as a cellular node or signal booster in a cellular network or another suitable wireless network (e.g., network 116). In additional embodiments, a ride-share entity can utilize resources of a vehicle herein to tailor respective route planning, resource distribution, unplanned maintenance handling, or other suitable operations.

According to an embodiment, the compute request can comprise a mapping request. Such a mapping request can comprise a request to utilize sensor fusion (e.g., using mapping components of the vehicle 120) and make said mapping components (e.g., sensors) available to an entity (e.g., associated with the device 118). For example, the mapping request can be associated with a particular location (e.g., to performing mapping or street view photography at the location) in order to improve a map or street view (e.g., 360-degrees panorama view of a road or other location). In this regard, the location component 204 can determine a location of the vehicle 120 and/or the route component 206 can determine a route of the vehicle 120. In this regard, in response to a determination (e.g., by the route component 206) that the route of the vehicle 120 satisfies a route criterion (e.g., travels along a road(s)), the navigation component 208 can allocate navigation hardware (e.g., mapping components) of the vehicle 120 to the mapping request. In this regard, the communication component 114 can send such data and/or images to the device 118 via the network 116. In additional embodiments, such a computing request can be satisfied while the vehicle 120 is engaged in autonomous driving.

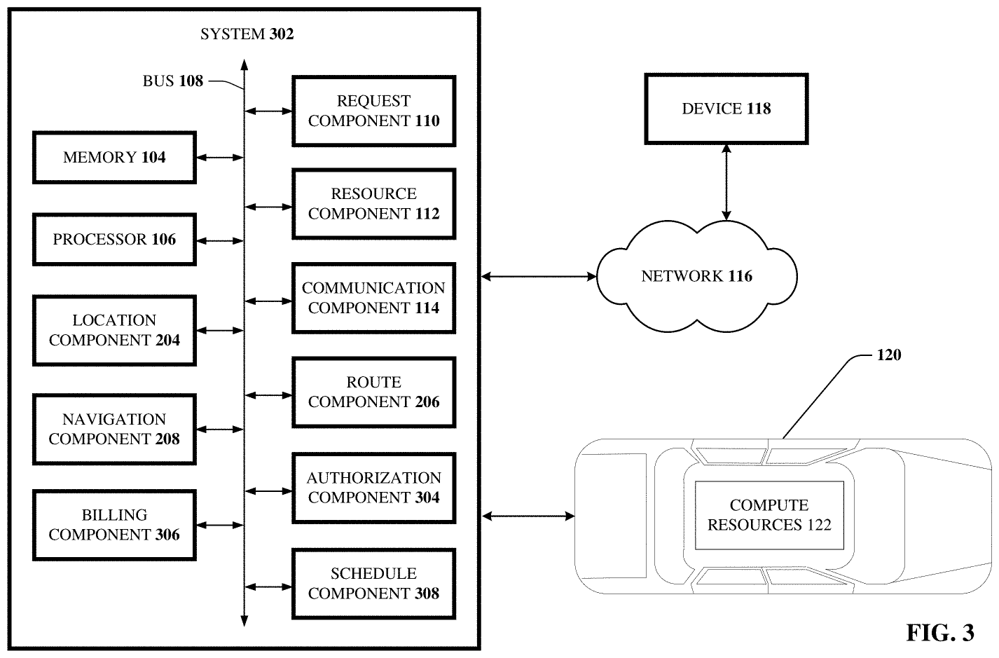

Turning now to FIG. 3, there is illustrated an example, non-limiting system 302 in accordance with one or more embodiments herein. System 302 can comprise a computerized tool, which can be configured to perform various operations relating to distributed computing (e.g., using a vehicle). The system 302 can be similar to system 202, and can comprise one or more of a variety of components, such as memory 104, processor 106, bus 108, request component 110, resource component 112, communication component 114, location component 204, route component 206, and/or navigation component 208. The system 302 can additionally comprise an authorization component 304, billing component 306, and/or schedule component 308.

In various embodiments, one or more of the memory 104, processor 106, bus 108, request component 110, resource component 112, communication component 114, device 118, vehicle 120, location component 204, route component 206, navigation component 208, authorization component 304, billing component 306, and/or schedule component 308 can be communicatively or operably coupled (e.g., over a bus or wireless network) to one another to perform one or more functions of the system 302.

According to an embodiment, the authorization component 304 can determine (e.g., via an interface of the vehicle) an authorization to allocate at least some of the compute resources of the vehicle to the compute request. In this regard, the compute criterion can comprise and/or be associated with the authorization. For example, a vehicle 120 can be engaged in autonomous driving and can concurrently receive a request to allocate at least some of the compute resources 122 to a compute request. The authorization can be prompted to a user of the vehicle 120, for instance, via a graphical user interface of the vehicle 120, speaker/microphone of the vehicle 120 or otherwise presented to a user (e.g., of the vehicle 120). In this regard, in response to the user authorizing the allocation, the resource component 112 can allocate at least some compute resource (e.g., according to the authorization) to satisfy the compute request. It is noted that the authorization can comprise discontinuing autonomous driving and/or disabling other systems of the vehicle 120 in order to make said compute resources available to satisfy the compute request.

According to an embodiment, the billing component 306 can, in response to allocating the at least some of the compute resources of the vehicle to the compute request, automatically bill an entity associated with the compute request for the allocation of the at least some of the compute resources (e.g., in response to satisfaction of the compute request). In this regard, such a compute request can comprise an incentive (e.g., for a user of the vehicle 120) to authorize the compute request. For example, an immediate need for compute resources may arise (e.g., a natural disaster occurs, and additional compute resources are needed by a telecommunications entity, associated with a device 118, to accommodate an influx of video calls). In this regard, the billing component 306 can automatically generate a bill or invoice, and send said bill or invoice to the entity. In further embodiments, the billing component 306 can automatically debit funds from the entity (e.g., according to the compute request and/or authorization) and deposit said funds into an account associated with the vehicle 120 and/or a user of the vehicle 120 registered with the system 302. It is noted that the bill or invoice can comprise an amount defined according to the compute request and/or authorization, or can comprise a rate (e.g., based on time of resource allocation, amount of data computed and/or transmitted, or other suitable factors). For instance, the amount of the bill or invoice can be based on the amount of time that resources are allocated to the compute request and/or the amount of data computed and/or transmitted, associated with the compute request. In further embodiments, a social media entity (e.g., Facebook, Tik Tok, Instagram, Twitter, Snapchat, YouTube, Reddit, or another social media entity as would be understood by one skilled in the art) can experience an influx in user activity. Similarly, an internet provider can request that a vehicle 120 operate as an internet proxy. Likewise, a streaming provider entity (e.g., Netflix, Amazon Prime Video, Hulu, or another suitable streaming provider entity as would be understood by one skilled in the art) can request that the vehicle 120 operate as a streaming proxy. In these examples, compute resources, network equipment and/or other components or resources (e.g., compute resources 122) of the vehicle 120 and associated systems can be allocated to an entity (e.g., associated with the device 118) and associated compute request. In another example, a compute request can comprise an incentive for a vehicle to move into a high-speed data coverage zone (e.g., of the network 116), so that data can be transmitted more rapidly (e.g., as compared a lower-speed data coverage zone). For example, the compute request can comprise an incentive for the vehicle 120 to navigate (e.g., autonomously) into a 5G mmWave coverage area (e.g., from a 4G LTE coverage area) to facilitate more rapid data transmission via the communication component 114 over the network 116. In another example, a compute request can comprise an incentive for the vehicle 120 to navigate to a lower cost region (e.g., based on data costs, energy costs, parking costs, or other suitable costs). Further, the resource component 112 can determine and/or estimate carbon emissions associated with utilizing compute resources described herein. For example, the resource component 112 can determine whether it would generate more carbon emissions to conduct compute functions locally or remotely. For example, if local resources are already active and/or at normal operating temperature, utilizing local resources can be determined to generate less carbon emission than initializing remote resources (e.g., in a cloud computing environment or of another vehicle). Further, such a determination can be based on emissions standards in one or more locations or jurisdictions.

According to an embodiment, the schedule component 308 can determine schedule information associated with a vehicle 120. In this regard, the schedule component 308 can determine schedule information representative of a schedule of a mobile device communicatively coupled to the vehicle 120, service (e.g., repair) schedule information associated with the vehicle 120, or other suitable schedule information. In this regard, a compute criterion being determined to be satisfied can comprise a determination (e.g., by the schedule component 308) that the schedule information representative of a schedule associated with the vehicle (e.g., or associated mobile device, user, or other entity) indicates that the vehicle will not be engaged in driving for a period of time that satisfies the compute request. For example, the schedule component 308 can determine that the vehicle 120 will be parked for approximately two hours while a user of the vehicle 120 is at a restaurant eating dinner (e.g., according to a calendar of a mobile device associated with the user and/or the vehicle 120). In this example, the defined period of time can comprise one hour, and thus said schedule information can thus satisfy the compute criterion. Further, the schedule component 306 can reschedule various operations herein (e.g., resource sharing, charging) based on carbon emission considerations associated with such operations (e.g., as determined by the resource component 112).

It is noted that one or more components herein (e.g., the request component 110, resource component 112, communication component 114, location component 204, route component 206, navigation component 208, authorization component 304, billing component 306, schedule component 308, or other suitable components) can leverage artificial intelligence and/or machine learning in order to make various determinations, predictions, data acquisitions, or estimations herein. Further, various defined thresholds herein can be determined using such machine learning (e.g., based on past information).

Artificial-intelligence or machine learning systems and techniques can be employed to facilitate learning user behavior, context-based scenarios, load habits, preferences, etc. in order to facilitate taking automated action with high degrees of confidence. Utility-based analysis can be utilized to factor benefit of taking an action against cost of taking an incorrect action. Probabilistic or statistical-based analyses can be employed in connection with the foregoing and/or the following.

According to an embodiment, components herein can comprise and/or employ an artificial intelligence (AI) model and/or a machine learning (ML) model that can learn to perform the above or below described functions (e.g., via training using historical training data and/or feedback data).

In some embodiments, components herein can comprise an AI and/or ML model that can be trained (e.g., via supervised and/or unsupervised techniques) to perform the above-described functions using historical training data comprising various context conditions. In this example, such an AI and/or ML model can further learn (e.g., via supervised and/or unsupervised techniques) to perform the above-described functions using training data comprising feedback data, where such feedback data can be collected and/or stored (e.g., in memory 104). In this example, such feedback data can comprise the various instructions described above/below that can be input over time in response to observed/stored context-based information.

One or more components herein can initiate an operation based on a defined level of confidence determined using information (e.g., feedback data). For instance, based on learning to perform such functions described above using the above defined feedback data, one or more components herein can determine appropriate corresponding actions.

In an embodiment, components herein can perform a utility-based analysis that factors cost of initiating the above-described operations versus benefit. In this embodiment, a component herein can use one or more additional context conditions to determine whether any action should be taken. In another embodiment, components herein can perform a utility-based analysis that factors an environmental cost (e.g., carbon emissions or other environmental costs) of initiating the above-described operations versus benefit. In this embodiment, a component herein can use one or more of the additional context conditions to determine whether any action should be taken.

To facilitate the above-described functions, components herein can perform classifications, correlations, inferences, and/or expressions associated with principles of artificial intelligence. Additionally, components herein can enable automatic control (e.g., of a vehicle herein). For instance, components herein can employ an automatic classification system and/or an automatic classification. In one example, a component herein can employ a probabilistic and/or statistical-based analysis (e.g., factoring into the analysis utilities and costs) to learn and/or generate inferences. A component herein can employ any suitable machine-learning based techniques, statistical-based techniques and/or probabilistic-based techniques. For example, a component herein can employ expert systems, fuzzy logic, support vector machines (SVMs), Hidden Markov Models (HMMs), greedy search algorithms, generative adversarial networks, rule-based systems, Bayesian models (e.g., Bayesian networks), neural networks, other non-linear training techniques, data fusion, utility-based analytical systems, systems employing Bayesian models, and/or the like. In another example, a component herein can perform a set of machine learning computations. For instance, a component herein can perform a set of clustering machine learning computations, a set of logistic regression machine learning computations, a set of decision tree machine learning computations, a set of random forest machine learning computations, a set of regression tree machine learning computations, a set of least square machine learning computations, a set of instance-based machine learning computations, a set of regression machine learning computations, a set of support vector regression machine learning computations, a set of k-means machine learning computations, a set of spectral clustering machine learning computations, a set of rule learning machine learning computations, a set of Bayesian machine learning computations, a set of deep Boltzmann machine computations, a set of deep belief network computations, ensemble learning operations, voting classifiers, and/or a set of different machine learning computations.

FIG. 4 illustrates an example, non-limiting driving scenario 400 in accordance with one or more embodiments described herein. In driving scenario 400, vehicle 404 can comprise a first vehicle, and vehicle 406 can comprise a second vehicle. In various embodiments, the vehicle 404 can be similar to the vehicle 120, and the vehicle 406 can comprise the device 118 and/or also be similar to the vehicle 120. In an implementation, the second vehicle can be navigating behind the first vehicle (e.g., on the same road 402 and/or respective road condition). In this regard, a compute request (e.g., from the second vehicle) can comprise a road determination request (e.g., sent to the first vehicle). Such a road condition determination request can comprise a request for information regarding one or more of a traffic condition, a road quality (e.g., potholes, bumps), road hazards (e.g., rain, snow, debris, obstacles), emergency vehicles (e.g., police cars or ambulances on the road), an accident (e.g., a crash), or other suitable road condition information. In this regard, the first vehicle can determine such road condition information (e.g., using one or more sensors of the vehicle 120) and provide such road condition information to the second vehicle (and/or provide resources needed to discern such information). In an example, resources of vehicle 406 can be made available, for instance, to vehicle 404 for autonomous driving compute functions or other suitable functions. Similarly, resources of vehicle 404 can be made available to vehicle 406 for autonomous driving compute functions or other suitable functions.

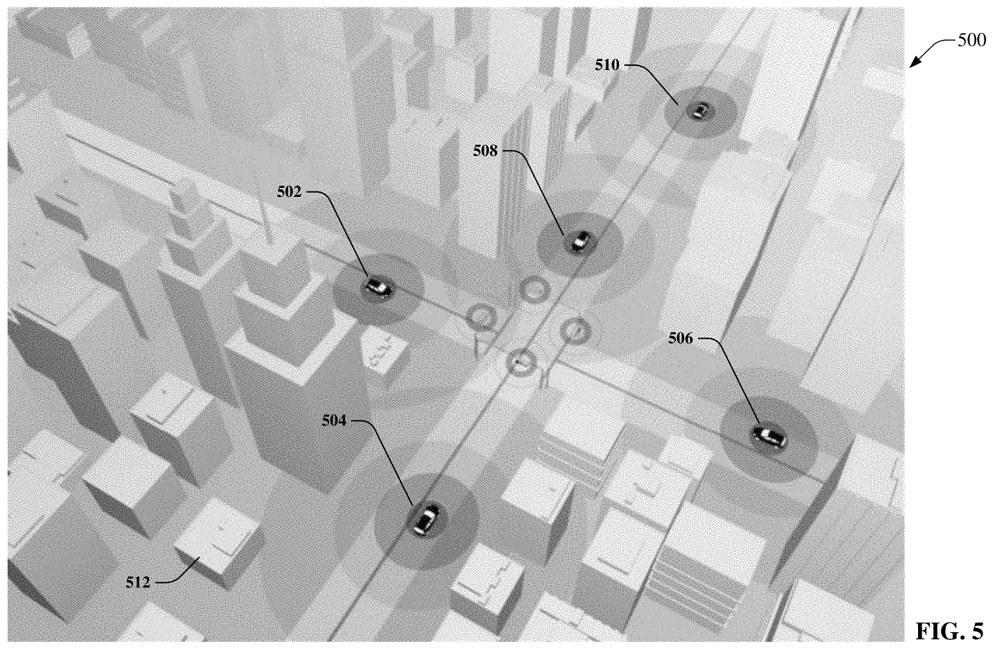

FIG. 5 illustrates an example, non-limiting scenario 500 in accordance with one or more embodiments described herein. In this regard, one or more of vehicle 502, vehicle 504, vehicle 506, vehicle 508, and/or vehicle 510 can be communicatively connected to a network (e.g., network 116). In this regard, one or more of the vehicle 502, vehicle 504, vehicle 506, vehicle 508, and/or vehicle 510 can be similar to the vehicle 120. Further in this regard, the entity 512 can comprise the device 118. For example, the entity 512 can generate and send a compute request to be communicated over the network 116. The compute request can be received by one or more of the vehicles 502, 504, 506, 508, and/or 510. In this regard, one or more of said vehicles can allocate respective compute resources to the compute request from the entity 512. Such vehicle(s) can be selected based on a highest respective percentage or volume of available resources, respective length of time capable of allocating resources, lowest respective cost associated with allocating resources (e.g., to be billed to the entity 512), lowest computational latency, or other suitable factors. It is noted that one or more proxy components or relay components can be utilized in the transmission of requests and associated data herein.

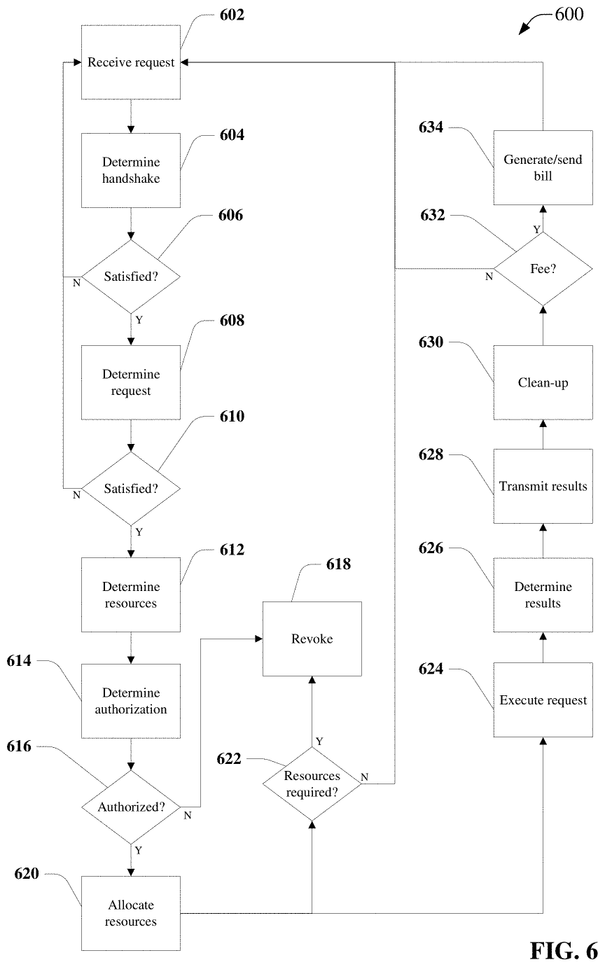

Turning now to FIG. 6, there is illustrated a flowchart of a process 600 relating to distributed computing (e.g., using a vehicle) in accordance with one or more embodiments described herein. It is noted that various embodiments herein can utilize blockchain-based recording technologies. At 602 a request (e.g., a compute request) can be received (e.g., via a communication component 114). At 604, a handshake can be determined. For example, such a handshake can comprise a blockchain-based handshake. Such a handshake can be utilized in order to determine whether the request received at 602 comprises a legitimate or authorized request. At 606, if the handshake is satisfied, the process can proceed to 608. Otherwise, the request can be ignored and/or revoked, and the process can return to 602. At 608, the compute request can be determined (e.g., by a request component 110). For example, the request component 110 can determine a type (and/or respective size or complexity) of compute request that is requested and associated information (e.g., resources requested, length of time requested, associated location(s), associated inventive(s), or other suitable information). In another example, the request component 110 can determine whether the compute request comprises a split request, with some computations occurring being requested to occur at the vehicle 112 and other computations occurring elsewhere (e.g., cloud-based). At 610, the resource component 112 can determine whether the compute request is satisfied (e.g., or can be satisfied). For example, the resource component 112 can determine whether the vehicle (e.g., a vehicle 120) comprises sufficient available resources to satisfy the request. Similarly, the resource component can determine whether the vehicle is busy or whether the vehicle can accept a query. In further embodiments, a location component 204 can determine whether a vehicle is, or predict that the vehicle will be, within a threshold distance of a location (e.g., and/or of a device 118) or within a geofence. In additional embodiments, the route component 206 can determine whether the vehicle 120 will remain within a threshold distance (e.g., of the location or device 118) or within the geofence for at least as threshold amount of time (e.g., according to the compute request). In further embodiments, the compute request can comprise a request to autonomously navigate (e.g., using the navigation component 208) the vehicle 120 to a defined location and/or allocate navigation resources (e.g., to the device 118). It is noted that the determination of whether/where to allocate resources of the vehicle 120 (e.g., allocate to the vehicle 120, or decline to allocate to the vehicle 120 and thus facilitate the compute request via external resources) can be based in part on carbon emissions and/or respective quotas associated with the resources. For example, based on charge levels, energy sources, or other factors, the resource component 112 can determine carbon emissions or other suitable environmental factors associated with the facilitation of the request (e.g., via the vehicle 120 or elsewhere). At 610, if the compute request is determined or predicted to be satisfied, the process can proceed to 612. Otherwise, the process can return to 602. At 612, the resource component 112 can determine which compute resources (e.g., of the compute resources 122) to allocate to the compute request. In various embodiments, the vehicle 120 can comprise defined allocation limits. For example, said defined allocation limits can be according to a task being conducted (or to be conducted) by the vehicle 120 (e.g., such as autonomous driving). In this regard, if the vehicle 120 is engaged in autonomous driving, the vehicle 120 can be limited to allocating zero or a defined limit (e.g., quantity, percentage, etc.) of said resources. At 614, an authorization can be determined (e.g., by the authorization component 304). At 616, If the authorization is received (e.g., via a graphical user interface of the vehicle 120, via a mobile device communicatively coupled to the vehicle 120, or otherwise received), the process can proceed to 620. If at 616, the authorization is not received, the compute request can be revoked or denied at 618. At 620, resources (e.g., as determined in step 612) can be allocated to the compute request (e.g., by the resource component 112). If at 622, the allocated compute resources are determined (e.g., by the resource component 112) to be required by the vehicle 120 (e.g., after the allocation to the device 118), the allocation of the resources can be revoked at 618. Otherwise, the allocation can continue (e.g., according to the compute request) until completed, and the process can return to 602. It is noted that the resource check conducted at 622 can be conducted at any point in the process 600 (e.g., during steps 620-634 or during other steps). At 624, the request (e.g., the request that was received at 602) can be executed. At 626, results associated with the request (e.g., completion of execution of the request) can be determined. At 628, the results determined at 626 can be transmitted (e.g., using a communication component 114) to an entity associated with the request. At 630, “clean-up” can occur. In this regard, memory allocated to the request can be unallocated. It is noted that process 600 can additionally comprise generating/sending (e.g., using the billing component 306) a bill (e.g., associated with the compute request). For example, if the compute request (e.g., the request received at 602) comprised an incentive (e.g., Y at 632), the process can proceed to 634 at which a bill can be generated and/or sent (e.g., using the billing component 306) to an entity (e.g., and/or device 118) associated with the compute request. In further embodiments, the billing component 306 can automatically debit funds from the entity (e.g., according to the compute request and/or authorization) and deposit said funds into an account associated with the vehicle 120 and/or a user of the vehicle 120 registered with the system 302. It is noted that the bill or invoice can comprise an amount defined according to the compute request and/or authorization, or can comprise a rate (e.g., based on time of resource allocation, amount of data computed and/or transmitted, or other suitable factors). It is noted that in some embodiments, the bill or invoice can be based in part on associated carbon emissions generated as a consequence of the facilitation of the compute request. If at 632 no fee/incentive is provided, the process 600 can return to 602.

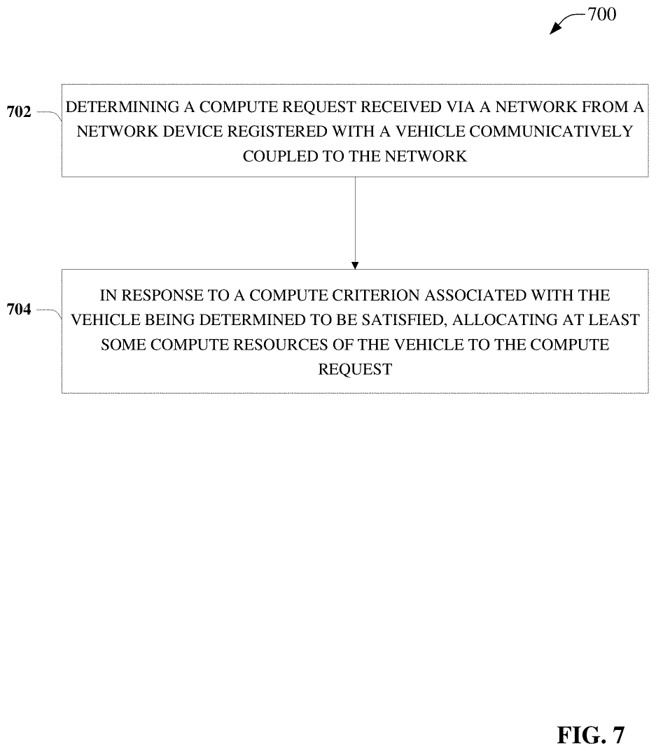

FIG. 7 illustrates a block flow diagram for a process 700 associated with distributed computing (e.g., using a vehicle) in accordance with one or more embodiments described herein. At 702, the process 700 can comprise determining a compute request received via a network from a network device registered with a vehicle communicatively coupled to the network. At 704, the process 700 can comprise, in response to a compute criterion associated with the vehicle being determined to be satisfied, allocating at least some compute resources of the vehicle to the compute request.

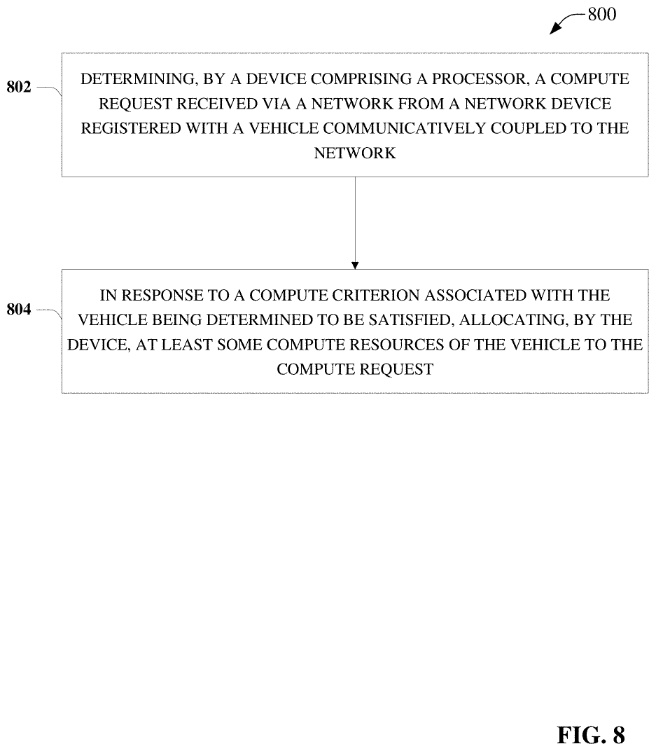

FIG. 8 illustrates a block flow diagram for a process 800 associated with distributed computing (e.g., using a vehicle) in accordance with one or more embodiments described herein. At 802, the process 800 can comprise determining, by a device comprising a processor, a compute request received via a network from a network device registered with a vehicle communicatively coupled to the network. At 802, the process 800 can comprise, in response to a compute criterion associated with the vehicle being determined to be satisfied, allocating, by the device, at least some compute resources of the vehicle to the compute request.

Systems described herein can be coupled (e.g., communicatively, electrically, operatively, optically, inductively, acoustically, etc.) to one or more local or remote (e.g., external) systems, sources, and/or devices (e.g., electronic control systems (ECU), classical and/or quantum computing devices, communication devices, etc.). For example, system 102 (or other systems, controllers, processors, etc.) can be coupled (e.g., communicatively, electrically, operatively, optically, etc.) to one or more local or remote (e.g., external) systems, sources, and/or devices using a data cable (e.g., High-Definition Multimedia Interface (HDMI), recommended standard (RS), Ethernet cable, etc.) and/or one or more wired networks described below.

In some embodiments, systems herein can be coupled (e.g., communicatively, electrically, operatively, optically, inductively, acoustically, etc.) to one or more local or remote (e.g., external) systems, sources, and/or devices (e.g., electronic control units (ECU), classical and/or quantum computing devices, communication devices, etc.) via a network. In these embodiments, such a network can comprise one or more wired and/or wireless networks, including, but not limited to, a cellular network, a wide area network (WAN) (e.g., the Internet), and/or a local area network (LAN). For example, system 102 can communicate with one or more local or remote (e.g., external) systems, sources, and/or devices, for instance, computing devices using such a network, which can comprise virtually any desired wired or wireless technology, including but not limited to: powerline ethernet, VHF, UHF, AM, wireless fidelity (Wi-Fi), BLUETOOTH®, fiber optic communications, global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), high speed packet access (HSPA), Zigbee and other 802.XX wireless technologies and/or legacy telecommunication technologies, Session Initiation Protocol (SIP), ZIGBEE®, RF4CE protocol, WirelessHART protocol, L-band voice or data information, 6LoWPAN (IPv6 over Low power Wireless Area Networks), Z-Wave, an ANT, an ultra-wideband (UWB) standard protocol, and/or other proprietary and non-proprietary communication protocols. In this example, system 102 can thus include hardware (e.g., a central processing unit (CPU), a transceiver, a decoder, an antenna (e.g., a ultra-wideband (UWB) antenna, a BLUETOOTH® low energy (BLE) antenna, etc.), quantum hardware, a quantum processor, etc.), software (e.g., a set of threads, a set of processes, software in execution, quantum pulse schedule, quantum circuit, quantum gates, etc.), or a combination of hardware and software that facilitates communicating information between a system herein and remote (e.g., external) systems, sources, and/or devices (e.g., computing and/or communication devices such as, for instance, a smart phone, a smart watch, wireless earbuds, etc.).

System herein can comprise one or more computer and/or machine readable, writable, and/or executable components and/or instructions that, when executed by processor (e.g., a processor 106 which can comprise a classical processor, a quantum processor, etc.), can facilitate performance of operations defined by such component(s) and/or instruction(s). Further, in numerous embodiments, any component associated with a system herein, as described herein with or without reference to the various figures of the subject disclosure, can comprise one or more computer and/or machine readable, writable, and/or executable components and/or instructions that, when executed by a processor, can facilitate performance of operations defined by such component(s) and/or instruction(s). Consequently, according to numerous embodiments, system herein and/or any components associated therewith as disclosed herein, can employ a processor (e.g., processor 106) to execute such computer and/or machine readable, writable, and/or executable component(s) and/or instruction(s) to facilitate performance of one or more operations described herein with reference to system herein and/or any such components associated therewith.

Systems herein can comprise any type of system, device, machine, apparatus, component, and/or instrument that comprises a processor and/or that can communicate with one or more local or remote electronic systems and/or one or more local or remote devices via a wired and/or wireless network. All such embodiments are envisioned. For example, a system (e.g., a system 302 or any other system or device described herein) can comprise a computing device, a general-purpose computer, field-programmable gate array, AI accelerator application-specific integrated circuit, a special-purpose computer, an onboard computing device, a communication device, an onboard communication device, a server device, a quantum computing device (e.g., a quantum computer), a tablet computing device, a handheld device, a server class computing machine and/or database, a laptop computer, a notebook computer, a desktop computer, wearable device, internet of things device, a cell phone, a smart phone, a consumer appliance and/or instrumentation, an industrial and/or commercial device, a digital assistant, a multimedia Internet enabled phone, a multimedia players, and/or another type of device.

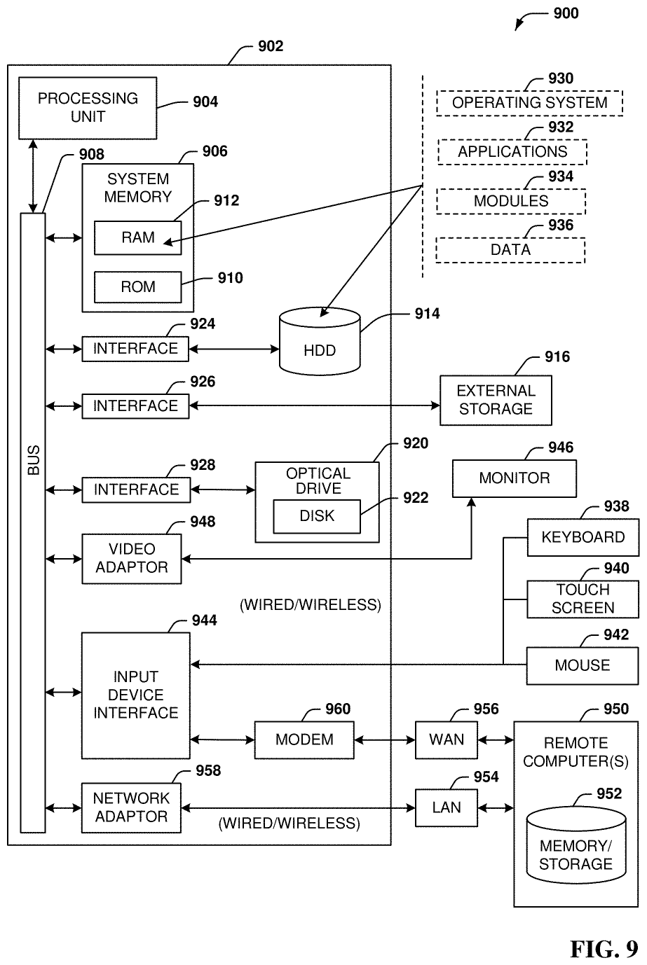

In order to provide additional context for various embodiments described herein, FIG. 9 and the following discussion are intended to provide a brief, general description of a suitable computing environment 900 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers (e.g., ruggedized personal computers), field-programmable gate arrays, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, optic, infrared, and other wireless media.

With reference again to FIG. 9, the example environment 900 for implementing various embodiments of the aspects described herein includes a computer 902, the computer 902 including a processing unit 904, a system memory 906 and a system bus 908. The system bus 908 couples system components including, but not limited to, the system memory 906 to the processing unit 904. The processing unit 904 can be any of various commercially available processors, field-programmable gate array, AI accelerator application-specific integrated circuit, or other suitable processors. Dual microprocessors and other multi-processor architectures can also be employed as the processing unit 904.

The system bus 908 can be any of several types of bus structure that can further interconnect to a memory bus (with or without a memory controller), a peripheral bus, and a local bus using any of a variety of commercially available bus architectures. The system memory 906 includes ROM 910 and RAM 912. A basic input/output system (BIOS) can be stored in a nonvolatile memory such as ROM, erasable programmable read only memory (EPROM), EEPROM, which BIOS contains the basic routines that help to transfer information between elements within the computer 902, such as during startup. The RAM 912 can also include a high-speed RAM such as static RAM for caching data. It is noted that unified Extensible Firmware Interface(s) can be utilized herein.

The computer 902 further includes an internal hard disk drive (HDD) 914 (e.g., EIDE, SATA), one or more external storage devices 916 (e.g., a magnetic floppy disk drive (FDD) 916, a memory stick or flash drive reader, a memory card reader, etc.) and an optical disk drive 920 (e.g., which can read or write from a CD-ROM disc, a DVD, a BD, etc.). While the internal HDD 914 is illustrated as located within the computer 902, the internal HDD 914 can also be configured for external use in a suitable chassis (not shown). Additionally, while not shown in environment 900, a solid-state drive (SSD) could be used in addition to, or in place of, an HDD 914. The HDD 914, external storage device(s) 916 and optical disk drive 920 can be connected to the system bus 908 by an HDD interface 924, an external storage interface 926 and an optical drive interface 928, respectively. The interface 924 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 902, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 912, including an operating system 930, one or more application programs 932, other program modules 934 and program data 936. All or portions of the operating system, applications, modules, and/or data can also be cached in the RAM 912. The systems and methods described herein can be implemented utilizing various commercially available operating systems or combinations of operating systems.

Computer 902 can optionally comprise emulation technologies. For example, a hypervisor (not shown) or other intermediary can emulate a hardware environment for operating system 930, and the emulated hardware can optionally be different from the hardware illustrated in FIG. 9. In such an embodiment, operating system 930 can comprise one virtual machine (VM) of multiple VMs hosted at computer 902. Furthermore, operating system 930 can provide runtime environments, such as the Java runtime environment or the .NET framework, for applications 932. Runtime environments are consistent execution environments that allow applications 932 to run on any operating system that includes the runtime environment. Similarly, operating system 930 can support containers, and applications 932 can be in the form of containers, which are lightweight, standalone, executable packages of software that include, e.g., code, runtime, system tools, system libraries and settings for an application.

Further, computer 902 can be enabled with a security module, such as a trusted processing module (TPM). For instance, with a TPM, boot components hash next in time boot components, and wait for a match of results to secured values, before loading a next boot component. This process can take place at any layer in the code execution stack of computer 902, e.g., applied at the application execution level or at the operating system (OS) kernel level, thereby enabling security at any level of code execution.

A user can enter commands and information into the computer 902 through one or more wired/wireless input devices, e.g., a keyboard 938, a touch screen 940, and a pointing device, such as a mouse 942. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 904 through an input device interface 944 that can be coupled to the system bus 908, but can be connected by other interfaces, such as a parallel port, an IEEE 1394 serial port, a game port, a USB port, an IR interface, a BLUETOOTH® interface, etc.

A monitor 946 or other type of display device can be also connected to the system bus 908 via an interface, such as a video adapter 948. In addition to the monitor 946, a computer typically includes other peripheral output devices (not shown), such as speakers, printers, etc.

The computer 902 can operate in a networked environment using logical connections via wired and/or wireless communications to one or more remote computers, such as a remote computer(s) 950. The remote computer(s) 950 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 952 is illustrated. The logical connections depicted include wired/wireless connectivity to a local area network (LAN) 954 and/or larger networks, e.g., a wide area network (WAN) 956. Such LAN and WAN networking environments are commonplace in offices and companies, and facilitate enterprise-wide computer networks, such as intranets, all of which can connect to a global communications network, e.g., the Internet.

When used in a LAN networking environment, the computer 902 can be connected to the local network 954 through a wired and/or wireless communication network interface or adapter 958. The adapter 958 can facilitate wired or wireless communication to the LAN 954, which can also include a wireless access point (AP) disposed thereon for communicating with the adapter 958 in a wireless mode.

When used in a WAN networking environment, the computer 902 can include a modem 960 or can be connected to a communications server on the WAN 956 via other means for establishing communications over the WAN 956, such as by way of the Internet. The modem 960, which can be internal or external and a wired or wireless device, can be connected to the system bus 908 via the input device interface 944. In a networked environment, program modules depicted relative to the computer 902 or portions thereof, can be stored in the remote memory/storage device 952. It will be appreciated that the network connections shown are example and other means of establishing a communications link between the computers can be used.

When used in either a LAN or WAN networking environment, the computer 902 can access cloud storage systems or other network-based storage systems in addition to, or in place of, external storage devices 916 as described above. Generally, a connection between the computer 902 and a cloud storage system can be established over a LAN 954 or WAN 956 e.g., by the adapter 958 or modem 960, respectively. Upon connecting the computer 902 to an associated cloud storage system, the external storage interface 926 can, with the aid of the adapter 958 and/or modem 960, manage storage provided by the cloud storage system as it would other types of external storage. For instance, the external storage interface 926 can be configured to provide access to cloud storage sources as if those sources were physically connected to the computer 902.

The computer 902 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

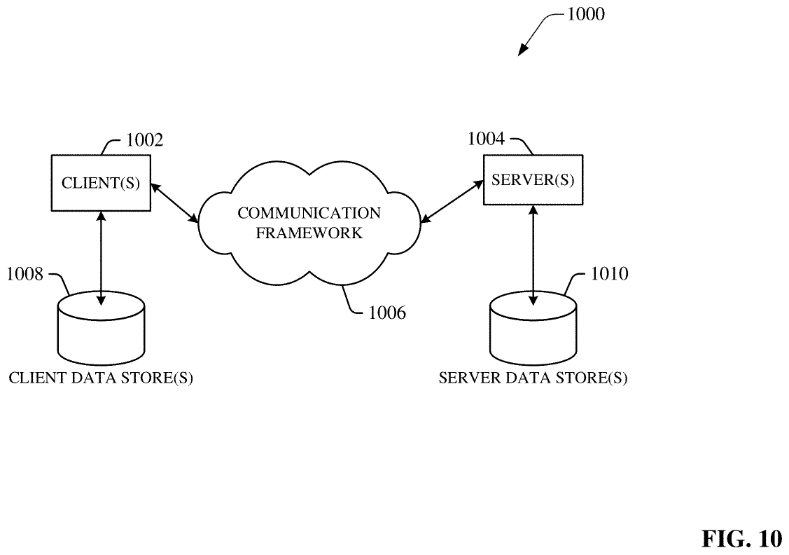

Referring now to FIG. 10, there is illustrated a schematic block diagram of a computing environment 1000 in accordance with this specification. The system 1000 includes one or more client(s) 1002, (e.g., computers, smart phones, tablets, cameras, PDA's). The client(s) 1002 can be hardware and/or software (e.g., threads, processes, computing devices). The client(s) 1002 can house cookie(s) and/or associated contextual information by employing the specification, for example.

The system 1000 also includes one or more server(s) 1004. The server(s) 1004 can also be hardware or hardware in combination with software (e.g., threads, processes, computing devices). The servers 1004 can house threads to perform transformations of media items by employing aspects of this disclosure, for example. One possible communication between a client 1002 and a server 1004 can be in the form of a data packet adapted to be transmitted between two or more computer processes wherein data packets may include coded analyzed headspaces and/or input. The data packet can include a cookie and/or associated contextual information, for example. The system 1000 includes a communication framework 1006 (e.g., a global communication network such as the Internet) that can be employed to facilitate communications between the client(s) 1002 and the server(s) 1004.

Communications can be facilitated via a wired (including optical fiber) and/or wireless technology. The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004. Further, the client(s) 1002 can be operatively connected to one or more server data store(s) 1010.

In one exemplary implementation, a client 1002 can transfer an encoded file, (e.g., encoded media item), to server 1004. Server 1004 can store the file, decode the file, or transmit the file to another client 1002. It is noted that a client 1002 can also transfer uncompressed file to a server 1004 and server 1004 can compress the file and/or transform the file in accordance with this disclosure. Likewise, server 1004 can encode information and transmit the information via communication framework 1006 to one or more clients 1002.

The illustrated aspects of the disclosure can also be practiced in distributed computing environments where certain tasks are performed by remote processing devices that are linked through a communications network. In a distributed computing environment, program modules can be located in both local and remote memory storage devices.

The above description includes non-limiting examples of the various embodiments. It is, of course, not possible to describe every conceivable combination of components or methods for purposes of describing the disclosed subject matter, and one skilled in the art can recognize that further combinations and permutations of the various embodiments are possible. The disclosed subject matter is intended to embrace all such alterations, modifications, and variations that fall within the spirit and scope of the appended claims.

With regard to the various functions performed by the above-described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature can be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

Further aspects of the invention are provided by the subject matter of the following clauses:

1. A system, comprising:

a memory that stores computer executable components; and

a processor that executes the computer executable components stored in the memory, wherein the computer executable components comprise:

a request component that determines a compute request received via a network from a network device registered to use the system; and

a resource component that, in response to a compute criterion associated with a vehicle communicatively coupled to the network being determined to be satisfied, allocates at least some compute resources of the vehicle to the compute request.

2. The system of any preceding clause, wherein the compute criterion comprises a threshold utilization percentage of the compute resources by the vehicle.

3. The system of any preceding clause, wherein the compute resources comprise compute resources not presently in use by the vehicle.

4. The system of any preceding clause, wherein the computer executable components further comprise:

a location component that determines a location of the vehicle, wherein the compute criterion being determined to be satisfied comprises a determination that the vehicle is located within a threshold distance of the network device.

5. The system of any preceding clause, wherein the computer executable components further comprise:

a route component that determines route information representative of a route of the vehicle, wherein the compute criterion being determined to be satisfied further comprises a determination, based on the route information, that the vehicle will remain within the threshold distance of the network device for at least a threshold amount of time.

6. The system of any preceding clause, wherein the resource component, in response to a determination that the vehicle requires compute resources of the vehicle presently in use by the network device, revokes the allocation of the compute resources of the vehicle presently in use by the network device.

7. The system of any preceding clause, wherein the at least some compute resources of the vehicle comprise a containerized worker node in a compute cluster.

8. The system of any preceding clause, wherein the computer executable components further comprise:

an authorization component that determines, via an interface of the vehicle, an authorization to allocate at least some of the compute resources of the vehicle to the compute request, wherein the compute criterion comprises the authorization.

9. The system of any preceding clause, wherein the computer executable components further comprise:

a navigation component that determines status information representative of a navigational status of the vehicle, and in response to a status criterion being determined to be satisfied by the status information, autonomously navigates the vehicle to a location associated with the compute request, wherein the compute request comprises location data representative of the location.

10. The system of any preceding clause, wherein the compute request comprises a network traffic request, and wherein the location comprises a defined region for cellular coverage to be supplemented via network hardware of the vehicle.

11. The system of any preceding clause, wherein the computer executable components further comprise:

a billing component that, in response to allocating the at least some of the compute resources of the vehicle to the compute request, automatically bills an entity associated with the compute request for the allocation of the at least some of the compute resources.

12. The system of clause 1 above with any set of combinations of the systems 2-11 above.

13. A non-transitory machine-readable medium, comprising executable instructions that, when executed by a processor, facilitate performance of operations, comprising:

determining a compute request received via a network from a network device registered with a vehicle communicatively coupled to the network; and

in response to a compute criterion associated with the vehicle being determined to be satisfied, allocating at least some compute resources of the vehicle to the compute request.

14. The non-transitory machine-readable medium of any preceding clause, wherein the compute request comprises a mapping request, and wherein the operations further comprise:

determining a route of a vehicle; and

in response to a determination that the route of the vehicle satisfies a route criterion, allocating navigation hardware of the vehicle to the mapping request.

15. The non-transitory machine-readable medium of any preceding clause, wherein the operations further comprise:

determining network status information representative of a signal strength and connection speed between the vehicle and the network, wherein the allocating at least some compute resources of the vehicle to the compute request further comprises allocating at least some compute resources of the vehicle to the compute request in response the network status information being determined to satisfy a network status threshold.

16. The non-transitory machine-readable medium of any preceding clause, wherein the vehicle comprises a plurality of processing units, and wherein the allocating at least some compute resources of the vehicle to the compute request comprise allocating at least one processing unit of the plurality of processing units.

17. The non-transitory machine-readable medium of any preceding clause, wherein the vehicle comprises a first vehicle, and wherein the network device comprises a second vehicle.

18. The non-transitory machine-readable medium of any preceding clause, wherein the second vehicle is navigating behind the first vehicle on a same road as the first vehicle, and wherein the compute request comprises a road condition determination request.

19. The non-transitory machine-readable medium of clause 13 above with any set of combinations of the non-transitory machine-readable mediums 14-18 above.

20. A method, comprising:

determining, by a device comprising a processor, a compute request received via a network from a network device registered with a vehicle communicatively coupled to the network; and in response to a compute criterion associated with the vehicle being determined to be satisfied, allocating, by the device, at least some compute resources of the vehicle to the compute request.

21. The method of any preceding clause, wherein the compute criterion being determined to be satisfied comprises a determination that the vehicle is charging.

22. The method of any preceding clause, wherein the compute criterion being determined to be satisfied comprises a determination that scheduling information representative of a schedule associated with the vehicle indicates that the vehicle will not be engaged in driving for a period of time that satisfies the compute request.

23. The method of clause 20 above with any set of combinations of the methods of clauses 21-22 above.

What is claimed is:

1. A system, comprising:
a memory that stores computer executable components; and
a processor that executes the computer executable components stored in the memory, wherein the computer executable components comprise:
a request component that determines a compute request received via a network from a network device registered to use the system; and
a resource component that, in response to a compute criterion associated with a vehicle communicatively coupled to the network being determined to be satisfied, allocates at least some compute resources of the vehicle to the compute request.

2. The system of claim 1, wherein the compute criterion comprises a threshold utilization percentage of the compute resources by the vehicle.

3. The system of claim 1, wherein the compute resources comprise compute resources not presently in use by the vehicle.

4. The system of claim 1, wherein the computer executable components further comprise:
a location component that determines a location of the vehicle, wherein the compute criterion being determined to be satisfied comprises a determination that the vehicle is located within a threshold distance of the network device.

5. The system of claim 4, wherein the computer executable components further comprise:
a route component that determines route information representative of a route of the vehicle, wherein the compute criterion being determined to be satisfied further comprises a determination, based on the route information, that the vehicle will remain within the threshold distance of the network device for at least a threshold amount of time.

6. The system of claim 1, wherein the resource component, in response to a determination that the vehicle requires compute resources of the vehicle presently in use by the network device, revokes the allocation of the compute resources of the vehicle presently in use by the network device.

7. The system of claim 1, wherein the at least some compute resources of the vehicle comprise a containerized worker node in a compute cluster.

8. The system of claim 1, wherein the computer executable components further comprise:
an authorization component that determines, via an interface of the vehicle, an authorization to allocate at least some of the compute resources of the vehicle to the compute request, wherein the compute criterion comprises the authorization.

9. The system of claim 1, wherein the computer executable components further comprise:
a navigation component that determines status information representative of a navigational status of the vehicle, and in response to a status criterion being determined to be satisfied by the status information, autonomously navigates the vehicle to a location associated with the compute request, wherein the compute request comprises location data representative of the location.

10. The system of claim 9, wherein the compute request comprises a network traffic request, and wherein the location comprises a defined region for cellular coverage to be supplemented via network hardware of the vehicle.

11. The system of claim 1, wherein the computer executable components further comprise:
a billing component that, in response to allocating the at least some of the compute resources of the vehicle to the compute request, automatically bills an entity associated with the compute request for the allocation of the at least some of the compute resources.

12. A non-transitory machine-readable medium, comprising executable instructions that, when executed by a processor, facilitate performance of operations, comprising:
determining a compute request received via a network from a network device registered with a vehicle communicatively coupled to the network; and
in response to a compute criterion associated with the vehicle being determined to be satisfied, allocating at least some compute resources of the vehicle to the compute request.

13. The non-transitory machine-readable medium of claim 12, wherein the compute request comprises a mapping request, and wherein the operations further comprise:
determining a route of a vehicle; and
in response to a determination that the route of the vehicle satisfies a route criterion, allocating navigation hardware of the vehicle to the mapping request.

14. The non-transitory machine-readable medium of claim 12, wherein the operations further comprise:
determining network status information representative of a signal strength and connection speed between the vehicle and the network, wherein the allocating at least some compute resources of the vehicle to the compute request further comprises allocating at least some compute resources of the vehicle to the compute request in response the network status information being determined to satisfy a network status threshold.

15. The non-transitory machine-readable medium of claim 12, wherein the vehicle comprises a plurality of processing units, and wherein the allocating at least some compute resources of the vehicle to the compute request comprise allocating at least one processing unit of the plurality of processing units.

16. The non-transitory machine-readable medium of claim 12, wherein the vehicle comprises a first vehicle, and wherein the network device comprises a second vehicle.

17. The non-transitory machine-readable medium of claim 16, wherein the second vehicle is navigating behind the first vehicle on a same road as the first vehicle, and wherein the compute request comprises a road condition determination request.

18. A method, comprising:
determining, by a device comprising a processor, a compute request received via a network from a network device registered with a vehicle communicatively coupled to the network; and
in response to a compute criterion associated with the vehicle being determined to be satisfied, allocating, by the device, at least some compute resources of the vehicle to the compute request.

19. The method of claim 18, wherein the compute criterion being determined to be satisfied comprises a determination that the vehicle is charging.

20. The method of claim 18, wherein the compute criterion being determined to be satisfied comprises a determination that scheduling information representative of a schedule associated with the vehicle indicates that the vehicle will not be engaged in driving for a period of time that satisfies the compute request.
